(19) United States
(12) Patent Application Publication
(10) Pub. No.: US 2024/0208835 A1
(43) Pub. Date: Jun. 27, 2024

(54) CATHODE MATERIAL INCLUDING BISMUTH-DOPED MANGANITE-BASED PEROVSKITE AND SOLID OXIDE FUEL CELL INCLUDING SAME

(71) Applicant: KOREA ADVANCED INSTITUTE OF SCIENCE AND TECHNOLOGY, Daejeon (KR)

(72) Inventors: Kang Taek LEE, Daejeon (KR); Kyung Taek BAE, Daejeon (KR); In Cheol JEONG, Daejeon (KR); Hyeong Min YU, Seoul (KR)

(73) Assignee: KOREA ADVANCED INSTITUTE OF SCIENCE AND TECHNOLOGY, Daejeon (KR)

(21) Appl. No.: 18/536,776

(22) Filed: Dec. 12, 2023

(30) Foreign Application Priority Data
Dec. 14, 2022 (KR) 10-2022-0175264

(51) Int. Cl. C01F 17/32; H01M 8/10

(52) U.S. Cl. CPC C01F 17/32; H01M 8/10; C01P 2002/34; C01P 2002/72; C01P 2004/01; C01P 2006/40

(57) ABSTRACT

The present disclosure relates to a cathode material including bismuth-doped manganite-based perovskite and having excellent electrochemical properties and long-term stability, and a solid oxide fuel cell including the same. A cathode material according to an embodiment includes bismuth-doped manganite-based perovskite which is represented by Formula 1 below and in which praseodymium strontium manganite is deponed with bismuth:

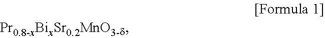

wherein in the Formula 1, x is in a range of 0<X<0.5, and δ is in a range of 0<δ<2.

### CROSS REFERENCE TO RELATED APPLICATION

The present application claims priority to Korean Patent Application No. 10-2022-0175264, filed Dec. 14, 2022, the entire contents of which are incorporated herein for all purposes by this reference.

### BACKGROUND OF THE INVENTION

### Field of the Invention

The present disclosure relates to a cathode material which includes bismuth-doped manganite-based perovskite and has excellent electrochemical properties and long-term stability, and a solid oxide fuel cell including the same.

### Description of the Related Art

In general, solid oxide cells (SOCs) are highly efficient and clean electrochemical energy conversion devices. SOCs are widely used as energy systems that can replace intermittent renewable energy because they can operate reversibly in a fuel cell (FC) mode for power generation and an electrolysis cell (EC) mode for hydrogen production.

Existing Solid oxide Cells operate at high temperatures of 750° C. or higher, so there are limitations in selecting materials for them, and there is a problem of increased system costs due to rapid performance degradation due to thermomechanical and chemical instability. Accordingly, various studies have recently been conducted on methods of lowering the operating temperature of Solid oxide Cells.

When the operating temperature of the solid oxide battery is lowered, the reactions at the cathode, including oxygen reduction reaction (ORR) in a fuel cell mode and oxygen evolution reaction (OER) in an electrolysis battery mode, slows down dramatically, which dominantly affects the performance of the solid oxide battery. Accordingly, research is being conducted with a focus on developing highly active cathodes including perovskite materials. As a cutting-edge cathode material, cobalt-containing perovskite oxide such as praseodymium barium strontium cobalt iron oxide (PBSCF), barium strontium cobalt iron oxide (BSCF), lanthanum strontium cobalt iron oxide (LSCF), which has excellent mixed ion, electronic conductivity (MIEC) and catalytic activity, is mainly used. The cobalt-containing perovskite oxide has improved oxygen vacancy formation and oxygen diffusion properties compared to other perovskites.

However, despite its high performance, the cobalt-containing perovskite oxide, when applied directly as a cathode, suffers from chemical instability, including surface segregation and decomposition, and thermo-mechanical incompatibility with yttria-stabilized zirconia (YSZ), the most popular electrolyte material, due to its high coefficient of thermal expansion.

Accordingly, additional coating is required for an electrode surface or a buffer layer between an electrode and an electrolyte, and alternative doping strategies that can suppress chemical reactions or thermal expansion by replacing cobalt are being proposed.

In this regard, the development of alternative materials has been emphasized and it is desirable to mitigate the harmful effects of cobalt-containing materials. Among cobalt-free perovskites, manganese-based perovskite materials such as Ln₁₋ₓSrₓMnO_{3-δ} (Ln=La, Pr, Nd, Sm, Gd, Yb or Y) have high electronic conductivity and a thermal expansion coefficient similar to that of YSZ. However, due to low ionic conductivity due to insufficient MIEC properties, the catalytic active site is mainly limited to the triple phase boundary (TPB) where electrode-electrolyte-air meet, and the reported catalytic activity is relatively low.

Although doping strategies have been used as one of the methods to improve oxygen ion transport properties in various studies, no significant improvement over the performance of cobalt-containing perovskites has been reported, even when elements including transition metal elements are considered as dopants. Accordingly, the development of manganese-based perovskite materials is experiencing a bottleneck, and the development focuses on the development of composite electrodes to extend the length of the three phase boundary (TPB) rather than the material properties themselves, so research on different types of methods that can complement such development is required.

### DOCUMENTS OF RELATED ART

(Non-Patent Document 1): Bismuth doped La0.75Sr0.25Cr0.5Mn0.5O3δ perovskite as a novel redox-stable efficient anode for solid oxide fuel cells (Shaowei Zhang, Yanhong Wan, Zheqiang Xu, Shuangshuang Xue, Lijie Zhang, Binze Zhanga and Changrong Xia, Journal of Materials Chemistry A, Issue 23, 2020)
(Non-Patent Document 2): Effect of bismuth doping on the physical properties of La—Li—Mn—O manganite (Kalyana Lakshmi Yanapu, Springer, February 2016)

### SUMMARY OF THE INVENTION

Therefore, in order to solve the above conventional problems, an embodiment of the present disclosure has an object to provide a technology related to a cathode material with excellent long-term stability while exhibiting high electrochemical properties by doping bismuth (Bi) into praseodymium strontium manganite-based perovskite, and a solid oxide fuel cell including the same.

The technical objects to be achieved by the present disclosure are not limited to the technical objects mentioned above, and other technical objects not mentioned may be clearly understood by those skilled in the art from the following descriptions.

In order to achieve the above objects, an embodiment of the present disclosure provides a cathode material comprising bismuth-doped manganite-based perovskite which is represented by Formula 1 below and in which praseodymium strontium manganite is deponed with bismuth:

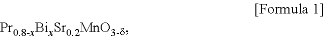

wherein in the Formula 1, x is in a range of 0<X<0.5, and δ is in a range of 0<δ<2.

According to an embodiment, in the Formula 1, x is in a range of 0.2<X<0.4.

According to an embodiment, the cathode material may be used as a material for manufacturing the cathode of a solid oxide fuel cell, especially a bidirectional solid oxide fuel cell.

Meanwhile, an embodiment of the present disclosure provides a method for manufacturing a cathode material comprising the steps of preparing a precursor mixture by mixing a praseodymium precursor, a bismuth precursor, a strontium precursor, a manganese precursor, and glycine with distilled water; preparing a dried precursor by drying the precursor mixture, heating the dried precursor, and then combusting the dried precursor to prepare a combustion product; and calcining the combustion product to manufacture a cathode material including a bismuth-doped manganite-based perovskite represented by Formula 1 below:

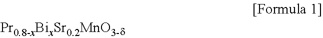

wherein in the Formula 1, x is in a range of 0<X<0.5, and δ is in a range of 0<δ<2.

Further, an embodiment of the present disclosure provides a bidirectional solid oxide fuel cell comprising a cathode manufactured with the cathode material of claim 1; an electrolyte layer located on the cathode; and an anode located on the electrolyte layer.

According to an embodiment, the bidirectional solid oxide fuel cell may exhibit a degradation rate of 6.3×10⁻⁷ V/h for 480 hours when 350 mA/Cm² is applied to the cathode at 700° C., and a power density of 0.58 to 2.24 W/Cm² at 600 to 750° C.

### BRIEF DESCRIPTION OF THE DRAWINGS

FIG. 1 is a process diagram illustrating a method for manufacturing a cathode according to an embodiment.

FIG. 2 is a diagram illustrating the results of X-ray diffraction pattern analysis for powder samples (PSM, PBSM1, PBSM3, and PBSM5) manufactured by a method according to Example.

FIG. 3 is a diagram illustrating the results of evaluating the electrical properties of a half-cell in which a cathode manufactured with powder samples (PSM, PBSM1, and PBSM3) according to Example was applied to YSZ electrolyte.

FIG. 4 is a diagram illustrating the results of analyzing the microstructure of a half cell in which a cathode manufactured with a powder sample (PBSM3) according to Example was applied to YSZ electrolyte.

FIG. 5 is a diagram illustrating the results of evaluating the performance a unit cell including a cathode manufactured with a powder sample (PBSM3) according to Example in fuel cell and electrolytic cell modes at each temperature.

FIG. 6 is a diagram illustrating the results of evaluating the long-term stability of a unit cell including a cathode manufactured with a powder sample (PBSM3) according to Example.

### DETAILED DESCRIPTION OF THE INVENTION

Hereinafter, exemplary embodiments of the present disclosure will be described in detail with reference to accompanying drawings. However, it should be understood that the present disclosure can be implemented in various forms, and that it is not intended to limit the present disclosure to the exemplary embodiments. Also, in the drawings, descriptions of parts unrelated to the detailed description are omitted to clearly describe the present disclosure. Throughout the specification, like numbers refer to like elements.

Throughout this specification, when a part is mentioned as being “connected (accessed, contacted, coupled)” to another part, this means that the part may not only be “directly connected” to the other part but may also be “indirectly connected” to the other part through another member interposed therebetween. In addition, when a part is mentioned as “including” a specific component, this does not preclude the possibility of the presence of other component(s) in the part which means that the part may further include the other component(s), unless otherwise stated.

The terms used herein are only used to describe specific embodiments but are not intended to limit the present disclosure. Singular forms are intended to include plural forms unless the context clearly indicates otherwise. In the specification, it should be understood that the terms such as “include” or “have” may be construed to denote a certain feature, number, step, operation, constituent element, component or a combination thereof, but may not be construed to exclude the existence of or a possibility of addition of one or more other features, numbers, steps, operations, constituent elements, components or combinations thereof.

Hereinafter, embodiments of the present disclosure will be described in detail with reference to the accompanying drawings.

The cathode material including bismuth-doped manganite-based perovskite according to an embodiment has a structure which is represented by the following Formula (1) and in which praseodymium strontium manganite (PrSrMnO) is deponed with bismuth (Bi).

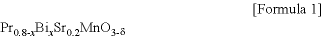

Accordingly, the above cathode material has a structure with improved electrochemical properties and long-term stability by the bismuth doping.

In order to exhibit the above characteristics, in Formula 1, x may be in the range of 0<x<0.5, and δ may be in the range of 0<δ<2.

In Formula 1, if x is 0, it is difficult to expect improvement in physical properties because bismuth is not doped, and if x exceeds 0.5, the amount of bismuth doping is large so that there is risk that physical properties may degrade due to the formation of secondary phases such as Pr_{1.1}Bi_{0.9}Mn₄O₁₀. That is, the bismuth-doped manganite-based perovskite preferably has a bismuth doping amount of more than 0 and less than 0.5 mol.

In particular, in Formula 1, x may be 0.2<X<0.4.

The bismuth (Bi)-doped manganite-based perovskite as described above can be used as a cathode material, and in particular, it can be used as a cathode material for a bidirectional solid oxide fuel cell.

The doping of bismuth (Bi) may be performed by a process of artificially implanting a dopant, such as diffusion or ion implantation, but is not limited thereto.

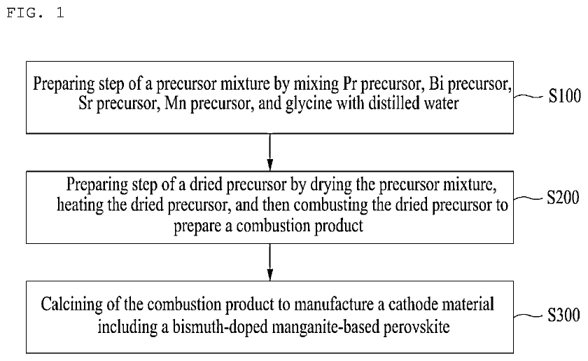

Meanwhile, FIG. 1 is a process diagram illustrating a method for manufacturing a cathode material according to an embodiment.

Referring to FIG. 1, a method for manufacturing a cathode material including bismuth-doped manganite-based perovskite represented by the following Formula 1 through a glycine nitrate process according to an embodiment includes the steps of preparing a precursor mixture (S100); preparing a combustion product (S200); and manufacturing a cathode material (S300).

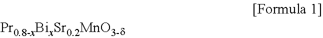

The method for manufacturing a cathode material will be described in detail. First, in the step of preparing the precursor mixture (S100), the precursor mixture may be prepared by mixing a praseodymium precursor, a bismuth precursor, a strontium precursor, a manganese precursor, and glycine with distilled water.

As the praseodymium precursor, the bismuth precursor, the strontium precursor, and the manganese precursor, various types of conventional precursors used for producing perovskite compounds may be used.

Specifically, as a representative example of the praseodymium precursor, there is praseodymium nitrate (Pr(NO₃)₃6H₂O), as a representative example of the bismuth precursor is bismuth nitrate (Bi(NO₃)₃5H₂O), as a representative example of the strontium precursor, there is strontium nitrate (Sr(NO₃)₂), and as a representative example of the manganese precursor, there is nitric acid. Manganese (Mn(NO₃)₂4H₂O).

In this step, the precursor mixture may be prepared by mixing the praseodymium precursor, bismuth precursor, strontium precursor, and manganese precursor in distilled water according to the stoichiometric ratio, then adding glycine to the mixture and mixing the mixture uniformly. The precursor mixture may be mixed by heating to a temperature of 50 to 90° C. so that the precursors and glycine may be uniformly mixed. Thereafter, moisture may be removed from the precursor mixture and the dried precursor may be combusted in the step to be described later to prepare a combustion product.

Next, in the step of preparing a combustion product (S200), moisture may be removed from the precursor mixture as described above, and then the precursor mixture may be combusted at a temperature of 200 to 500° C. In this step, a combustion product including manganite-based perovskite may be formed through a glycine nitrate process that induces an exothermic reaction between glycine and nitrate.

Next, in the step of manufacturing a cathode material (S300), the combustion product may be obtained and the obtained combustion product may be calcined to prepare a composite powder in which manganite-based perovskite is doped with bismuth. In this step, a calcination process may be performed at a temperature of 800 to 1,200° C. for 0.5 to 24 hours to prepare the composite powder including bismuth-doped manganite-based perovskite.

Thereafter, the bismuth-doped manganite-based perovskite as described above may be pulverized and prepared in powder form. Specifically, a commonly used method such as ball milling may be used for the pulverization, and the composite powder may be mixed with ethanol and then prepared into nanometer-sized particles through a ball milling process.

Meanwhile, a solid oxide fuel cell according to an embodiment may have a structure including a cathode manufactured with the above cathode material, an electrolyte layer located on the cathode, and an anode located on the electrolyte layer.

The solid oxide fuel cell having the above structure includes a cathode manufactured using the bismuth-doped manganite-based perovskite and exhibits improved electrochemical properties and long-term stability.

Specifically, in the solid oxide fuel cell, when 250 mA/Cm² is applied to the cathode at 700° C., it can exhibit a degradation rate of 6.3×10⁻⁷ V/h for 480 hours, showing excellent long-term stability.

In addition, the solid oxide fuel cell can exhibit a power density of 0.58 to 2.24 W/Cm² at 600 to 750° C. in a fuel cell mode, and a current density of 0.6 to 2.7 A/Cm² in an electrolytic cell mode, showing excellent electrical characteristics.

In particular, the solid oxide fuel cell may be a bidirectional solid oxide fuel cell, and the bidirectional solid oxide fuel cell may be doped with less than 0.5 mol of bismuth to form a cathode that exhibits high performance in a fuel cell mode and an electrolytic cell mode.

The cathode material according to the above-described embodiment exhibits high electrochemical properties and excellent long-term stability by doping bismuth (Bi) into a perovskite structure based on praseodymium strontium manganite, and thus, the cathode material can be used to manufacture a cathode for a solid oxide fuel cell.

Hereinafter, the present disclosure will be described in more detail through Examples.

The presented Examples are only specific examples of the present disclosure and are not intended to limit the technical scope of the present disclosure.

### Example

Nano-powder including praseodymium strontium manganite-based compound (Pr_{0.8-x}BiₓSr_{0.2}MnO_{3-δ}) having the composition shown in Table 1 was synthesized using a high-temperature continuous reaction method using a combustion material including glycine. Nano-powder was synthesized through the glycine nitrate process, which is a type of combustion synthesis process.

TABLE 1

| | |
|---|---|
| PSM | Pr_{0.8}Sr_{0.2}MnO_{3-δ} |
| PBSM1 | Pr_{0.7}Bi_{0.1}Sr_{0.2}MnO_{3-δ} |
| PBSM3 | Pr_{0.5}Bi_{0.3}Sr_{0.2}MnO_{3-δ} |
| PBSM5 | Pr_{0.3}Bi_{0.5}Sr_{0.2}MnO_{3-δ} |

Specifically, the bismuth-doped praseodymium strontium manganite-based compound (Pr_{0.8-x}BiₓSr_{0.2}MnO_{3-δ}) and praseodymium strontium manganite-based compound (Pr_{0.8}Sr_{0.2}MnO_{3-δ}) were each prepared as follows. First, the precursor materials including praseodymium nitrate (Pr(NO₃)₃6H₂O, Sigma aldrich, 99.9%), bismuth nitrate (Bi(NO₃)₃5H₂O, Alfa aesar, 98%), strontium nitrate (Sr(NO₃)₂, Alfa aesar, 99.0%), manganese nitrate (Mn(NO₃)₂4H₂O, Sigma aldrich, 97.0%) were prepared respectively, and the prepared precursor materials were mixed in distilled water according to the stoichiometric ratio and then stirred to prepare a mixture. Glycine was added to the prepared mixture and stirred at 80° C. to prepare a homogeneous mixed solution. Afterwards, the mixed solution was dried at 120° C. to evaporate all moisture, and then heated to 300° C. to induce a combustion reaction. After the combustion reaction, the remaining ash was pulverized using a mortar and pestle to prepare powder. The prepared powder was calcined at 1000° C. for 2 hours. Zirconia balls and ethanol were added to the obtained calcined material, and a ball-milling process was performed for 24 hours. After mixing and grinding, each of black final powder samples (PSM, PBSM1, PBSM3, and PBSM5) was obtained.

### <Experimental Example> (1) Crystal Structure Analysis

Powder XRD measurements were performed using an X-ray diffraction analyzer (RIGAKU, SmartLab) in the 20 range from 20 to 80° with Cu Kα radiation (2=1.5418 Å). The crystal structure of the powder was refined using HighScore software.

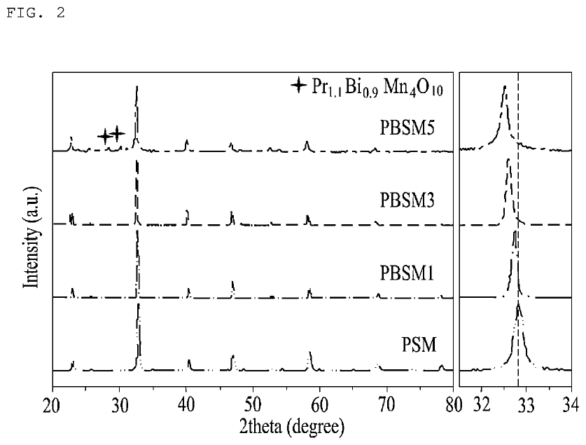

FIG. 2 shows the results of X-ray diffraction pattern analysis for powder samples (PSM, PBSM1, PBSM3, and PBSM5) prepared by the method according to Example.

As shown in FIG. 2, in the case of PBSM1, PBSM3, and PBSM5 in which PSM was doped with Bi, it was confirmed that an orthorhombic perovskite phase was formed. In addition, it was observed that the main peak around 32 to 33° shifted to a lower angle as the doping amount of bismuth increased. This result is due to the fact that the radius (1.13 Å) of the bismuth (Bi3⁺) ion is larger than the radius (1.17 Å) of the praseodymium (Pr³⁺) ion.

In addition, it was confirmed that in the case of PBSM5 with a bismuth doping amount of 0.5 mol or more, a secondary phase, Pr_{1.1}Bi_{0.9}Mn₄O₁₀, was formed.

### (2) Manufacturing of Half-Cell and Unit Cell

To manufacture a half-cell, yttria-stabilized Zirconia (YSZ, TOSHO) powder was placed in a mold, a pressure of 50 MPa was applied to the mold using uniaxial pressing, and then the mold was sintered at 1400° C. for 10 hours to form a YSZ pellet.

Tape casting and screen printing techniques were used to sequentially stack an anode support layer, an anode functional layer, and an electrolyte layer that constitute the unit cell.

### (3) Evaluation of Electrochemical Properties

Electrochemical properties of half-cells and unit cells were evaluated using a potentiostat (Bio-Logic, VMP-300). In this case, in the case of half cells, electrochemical property evaluation was performed in the air, and in the case of unit cells, hydrogen (3% wet) and air were injected into the anode and cathode, respectively.

In addition, the ionic conductivity of the prepared EYZB pellet was measured in a temperature range of 550 to 750° C. using a potentiostat. In addition, the long-term durability evaluation of the material was conducted at a temperature of 600° C.

In addition, XRD measurements of the pellets for long-term durability evaluation were performed using an X-ray diffraction analyzer (RIGAKU, SmartLab) in the 20 range from 20 to 80° with Cu Kα radiation (λ=1.5418 Å). The crystal structure of the corresponding pellet was refined using HighScore software.

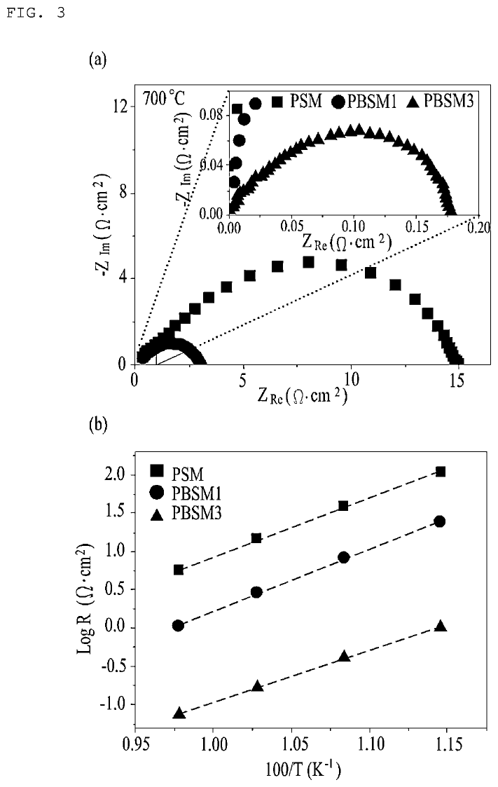

FIG. 3 shows the results of evaluating the electrical properties of a half-cell in which a cathode manufactured with powder samples (PSM, PBSM1, and PBSM3) according to Example was applied to YSZ electrolyte.

Referring to FIG. 3, in the case of a half cell in which PSM, PBSM1, and PBSM3 cathodes were applied to the YSZ electrolyte, it was confirmed that the electrode resistance decreased as the doping amount of bismuth increased, thereby improving the electrical characteristics.

### (4) Microstructure Analysis

Microstructural analysis of the unit cell was performed using a scanning electron microscope (SEM, Hitachi SU8230).

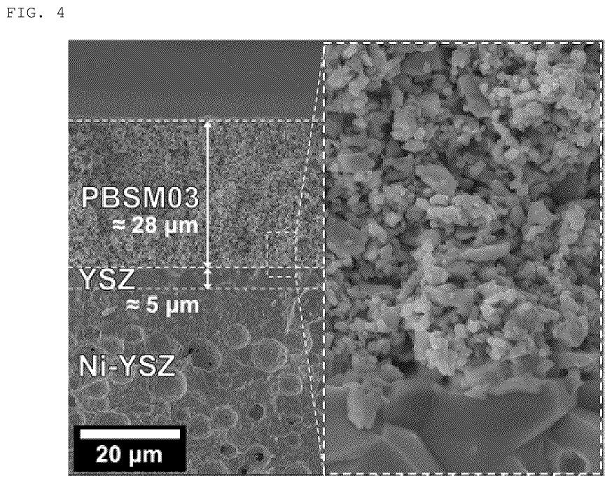

FIG. 4 shows the results of analyzing the microstructure of a half cell in which a cathode manufactured with a powder sample (PBSM3) according to Example was applied to YSZ electrolyte.

Referring to FIG. 4, it was confirmed that the cell was entirely constituted with a cathode, an electrolyte, and an anode, the electrolyte had a dense structure with a thickness of approximately 5 μm, and it was confirmed that the cathode and the electrolyte were each bonded without peeling.

### (5) Evaluation of Electrochemical Properties of Unit Cell

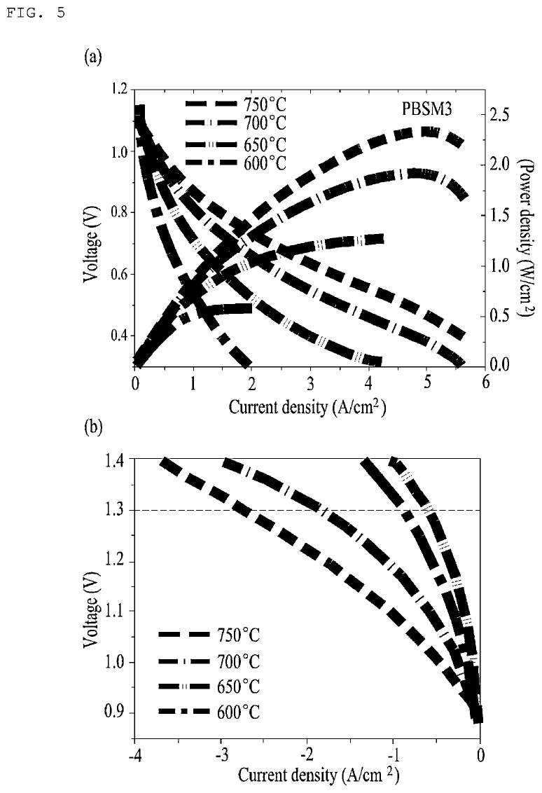

FIG. 5 shows the results of evaluating the performance of a unit cell including a cathode manufactured with a powder sample (PBSM3) according to Example in fuel cell and electrolytic cell modes at each temperature.

Referring to FIG. 5, it was confirmed that the powder density was 2.24, 1.90, 1.26, and 0.58 W/Cm² in a fuel cell mode, respectively, and 2.7, 1.9, 0.9, and 0.6 W/Cm² in an electrolytic cell mode, respectively, at 750° C., 700° C., 650° C., and 600° C.

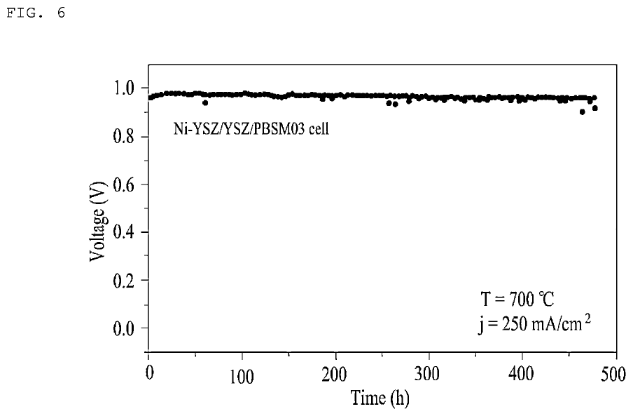

FIG. 6 shows the results of evaluating the long-term stability of a unit cell including a cathode manufactured with a powder sample (PBSM3) according to Example.

As shown in FIG. 6, it was confirmed that when 250 mA/Cm² was applied at 700° C., a degradation rate of 6.3×10⁻⁷ V/h was observed for 480 hours.

Through the above results, it was determined that the cathode material could be used as an oxygen electrode material for a reversible solid oxide battery with excellent performance and stability without a buffer layer on a popularly used YSZ electrolyte.

In addition, through crystallographic analysis, it was confirmed that impurities were formed when more than 0.5 mol of bismuth was doped into the manganite-based perovskite structure, and the perovskite with an orthorhombic structure was free of impurities when bismuth was doped to less than 0.5 mol.

In addition, as a result of evaluating the electrochemical properties of the half-cell to which the developed cathode was applied, it was confirmed that PBSM3 had the lowest electrode resistance. As a result of measuring the performance of the electrode in the fuel cell and electrolytic cell modes, it was confirmed to have high performance of 1.90 W/Cm² and 1.91 A/Cm², respectively, at 700° C. In addition, as a result of conducting a long-term stability evaluation at 700° C. in the fuel cell mode, it was confirmed that the degradation rate was 6.3×10⁻⁷ V/h over 480 hours.

Therefore, it was confirmed that the electrode had high performance and long-term stability when operating in the fuel cell and electrolytic cell modes on the most popularly used YSZ electrolyte without lamination of a buffer layer. In particular, it was confirmed that PBSM3 was a very promising material for reversible Solid oxide Cells.

The cathode material according to an embodiment exhibits high electrochemical properties and excellent long-term stability by doping bismuth (Bi) into a perovskite structure based on praseodymium strontium manganite. Accordingly, the cathode material may be used for manufacturing the cathode of a solid oxide fuel cell.

It should be understood that the effects of the present disclosure are not limited to the effects described above, but include all effects that can be deduced from the detailed description of the present disclosure or the constitution of the disclosure described in the claims.

Although the technical idea of the present disclosure described above has been described in detail in preferred embodiments, it should be noted that the above-described embodiments are for illustrative purposes only and are not intended for limitation. In addition, those skilled in the art of the present disclosure will understand that various embodiments are possible within the scope of the technical idea of the present disclosure. Therefore, the true technical protection scope of the present disclosure should be determined by the technical spirit of the attached claims.

What is claimed is:

1. A cathode material comprising bismuth-doped manganite-based perovskite which is represented by Formula 1 below and in which praseodymium strontium manganite is deponed with bismuth: 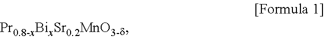
wherein in the Formula 1, x is in a range of 0<X<0.5, and δ is in a range of 0<δ<2.

2. The cathode material of claim 1, wherein in the Formula 1, x is in a range of 0.2<X<0.4.

3. The cathode material of claim 1, wherein the cathode material is used to for a bidirectional solid oxide fuel cell.

4. A method for manufacturing a cathode material comprising the steps of:
preparing a precursor mixture by mixing a praseodymium precursor, a bismuth precursor, a strontium precursor, a manganese precursor, and glycine with distilled water;
preparing a dried precursor by drying the precursor mixture, heating the dried precursor, and then combusting the dried precursor to prepare a combustion product; and
calcining the combustion product to manufacture a cathode material including a bismuth-doped manganite-based perovskite represented by Formula 1 below: 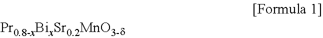
wherein in the Formula 1, x is in a range of 0<X<0.5, and δ is in a range of 0<δ<2.

5. The method of claim 4, wherein in the Formula 1, x is in a range of 0.2<X<0.4.

6. A bidirectional solid oxide fuel cell comprising:
a cathode manufactured with the cathode material of claim 1;
an electrolyte layer located on the cathode; and
an anode located on the electrolyte layer.

7. The bidirectional solid oxide fuel cell of claim 6, wherein when 350 mA/Cm² is applied to the cathode at 700° C., a degradation rate of 6.3×10⁻⁷ V/h for 480 hours is exhibited.

8. The bidirectional solid oxide fuel cell of claim 6, wherein a power density of 0.58 to 2.24 W/Cm² at 600 to 750° C. is exhibited.
